(19) United States
(12) Patent Application Publication
(10) Pub. No.: US 2008/0163156 A1
(43) Pub. Date: Jul. 3, 2008

(54) Software Solution for Project Management

(76) Inventor: Manuel S. Grey, Kitchener (CA)

Correspondence Address: MANUAL S GREY, 25 COUNTRYHILL DRIVE, UNIT 312, KITCHENER, ON, omitted

(21) Appl. No.: 11/967,827

(22) Filed: Dec. 31, 2007

Related U.S. Application Data
(60) Provisional application No. 60/878,219, filed on Jan. 3, 2007.

(51) Int. Cl. G06F 9/44

(52) U.S. Cl. 717/101

(57) ABSTRACT

A Project Management solution comprising: methods and best practices in Project management, algorithms, data base technologies; object oriented technologies, software security methods, web technologies, networking (WAN/LAN/ INTRANETS), smart devices and a Project Management knowledge base enabling a common interface for managing a project lifecycle of: initiation, planning, execution, controlling and closing stages. The Project Management solution is a comprehensive solution for Project Management that delivers real time project status, by means of functional layers and their intrinsic technologies.

This application claims benefit of U.S. Provisional Patent Application US60/878,219, filed Jan. 03, 2007 and entitled “Software Solution for Project Management”.

### CROSS-REFERENCE TO RELATE APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

The present invention relates to a Project Management Solution and specifically to computerized systems for Project Management (“PM”). The terminology contained in this application has the same meaning as set out in the glossary of the PMBOK© “A Guide to the Project Management Body of Knowledge”, third edition, 2004 (an American National Standard, ANSI/PMI 99-001-2004), Project Management Institute (PMI®).

A portion of the disclosure of this patent document contains material, which is subject to copyright protection. The copyright owner has no objection to the facsimile reproduction, by anyone, of the patent document or the patent disclosure as it appears in the Patent and Trademark Office patent file or records, but otherwise reserves all copyright rights whatsoever. The following notice applies to the software and data as described below and in the drawing hereto: Copyright 2005, Manuel S. Grey, Ontario, Canada. All Rights Reserved.

PM deals with two different types or process categories, as explained in the PMBOK©, A Guide to the Project Management Body of Knowledge, third edition, 2004 (an American National Standard, ANSI/PMI 99-001-2004), from the PMI®. The first type relates to the set of processes necessary to produce a project's results, the manufacturing oriented processes. The second type deals with the managerial processes necessary to secure successful accomplishment of the project's objectives, according to its scope, quality, and budget and time specifications (i.e. Risk, Procurement and others). The first type or category has been instrumental in designing commercial software solutions presently in today's market. These software solutions involve the dimensioning of the activity list, the necessary time or scheduling, associated cost, and the resources required in the undertaking. Although these types of software have been a good contribution to the PM field, they are not in concordance with public standards, nor with private strategies such as with IBM Rational© or Microsoft Solutions Framework©, which at least provide an apparent and cohesive framework from end to end specifically for IT projects.

U.S. Pat. No. 7,080,024 to Thompson provides a creation method, system and computer program product for analyzing the efficiency of a complex process, the method of analyzing a workload schedule, compared to available resources, is provided. This proposition does not include a WBS oriented change management system for managing all the inevitable change requirements.

U.S. Pat. No. 6,859,781 to Gloor, et al provides a business method for quality assurance services in IT including quality assurance method for formulating, proposing and delivery such services in a high quality manner. Even though the method is a good approach, it has limited applications, and is only for IT services and is not practiced in conjunction with the WBS. Quality Assurance as a best practice in PM has broad applications across diverse knowledge areas.

U.S. Pat. No. 6,591,300 to Yurkovic provides a system and a method which integrates group-related information from a plurality of sources, in order to provide a common platform for access and information sharing. Unfortunately the idea doesn't consider a formal approach in quality management or risk management, and the PM implications. The main body relies on the networking capabilities for information distribution. Currently there is a need for a more precise approach, in a broader context, with embedded standards and best practices.

U.S. Pat. No. 6,138,104 to Marchek, et al provides a product development system and method using integrated process and data management. A system and related method for managing the development of a project includes a memory device and at least one category definition stored in the memory device. The general approach is not conceived under a bigger context and the work management system and work break down structure are referred to in a narrow sense. It does not consider best practices in PM.

U.S. Pat. No. 5,848,394 to D'arrigo et al provides a method and system for producing a WBS for a project, such as a software development project. The system includes a function point as a value added proposition, which is very interesting. However, this reference does not utilize the WBS as a core component for quality or risk assessment and does not leverage the concept of a complete project lifecycle of: initiation, planning, execution, controlling and closing stages.

U.S. Pat. No. 5,907,490 to Oliver describes a system and method for PM and assessment where project task data is evaluated according to the Earned Value (“EV”) method and graphically displaying information which is used to monitor the performance of a project. Even though that approach is very interesting, it fails to integrate the totality of the process in a complete project lifecycle. One critical aspect of this option is that the EV method is not applied to deliverable-oriented work breakdown objects that are the natural inputs for this type of process. This is another example of lack of standardization and partially focused approaches.

Where these approaches, in the above referenced patents, provide specific treatment for a specific knowledge domain, one drawback, is that they fail to provide a comprehensive approach for PM, as aforementioned, and as it is referred in the PMBOK©, 2004.

A second drawback is the lack of integration. As we can see in the above-mentioned approaches, there is no integration of best practices, which is a key issue when dealing with solutions for PM, in particular the integral characteristic required, which produces unnecessary expensive processes. As it is well known, the sum of the parts does not produce a cohesive whole and what is required is an orchestrated system solution with embedded PM best practices.

A third drawback relates to proprietary schemas and specialization approaches. These are undesirable since they result in the need for a private or particular approach versus the standardized or open version, which has the purpose of conveying a standardized practice with the benefits this provides. This drawback applies to commercial products as well, i.e. MS Project©, PRIMAVERA©, QuickTime© and others.

The foregoing scenario reflects the demand for a comprehensive solution that essentially provides a management tool for stakeholders of dissimilar interests in a project, and most importantly, a PM system implementing methods, best practices and the general orchestration between all the implicated component processes, enabling a shared vision in the practice of the art of PM. Previous systems in the art have provided discrete and marginal managerial capability. In those systems, the common assumption is that a project is a collection of tasks to be resolved within a timeline and on a fixed budget, where the goals are to optimize the time duration of the project, or the use of resources.

### BRIEF SUMMARY OF THE INVENTION

It is an object of the present invention to provide a holistic PM system and method which orchestrates best practices in the art with Object Oriented Technologies (“OOT”), enabling an architecture of functional layers, for PM services independent of the field of application, and with the flexibility to facilitate project configuration profiles according to their complexity.

It is a further object of the present invention to provide a method for event-driven progressive elaboration, with incremental development of results, across project stages, processes and entities.

It is another object of the present invention to provide a Work Breakdown Structure (“WBS”) with event-driven processes enabling process-oriented deliverables.

It is an object of the present invention to provided an event-driven workspace using Atomic Operations, isolating the idiosyncrasies of an N-tier Client/Server application with simple, easy to use Windows© oriented interfaces, security subsystem and web services including data reporting.

It is a still further object of the present invention to provide access to a rich interface, with training specific files to guarantee that both the knowledge domain and the operational skills are developed when working with embodiments of the present invention.

Finally, it is a further object of the present invention to provide a solution that enables a shared PM vision across the PM community.

The present invention describes systems, clients, servers, event-driven methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE SEVERAL VIEWS OF THE DRAWINGS

FIG. 1—shows an exemplary system topology and diagram of the hardware and operating environment in conjunction with which embodiments of the invention may be practiced.

FIG. 2—is a schematic illustration of an exemplary integration and orchestration of plural PM classes, entities with functional layers and OOT, according to the present invention, to provide PM services.

FIG. 3—is a block diagram of an exemplary architecture of the system in accordance with the present invention.

FIG. 4.1—is an exemplary illustration of the layered service paradigm in the present invention to resolve service requirements.

FIG. 4.2—is an exemplary schematic diagram of Atomic Operations, access security and web services for reporting, within which embodiments of the present invention may be practiced.

FIG. 5—is an exemplary schematic diagram of a project configuration profile, within which embodiments of the present invention may be practiced.

FIG. 6a—is an exemplary schematic diagram for the WBS, within which embodiments of the present invention may be practiced.

FIG. 6b—is a data structure for WBS entities, in accordance with the present invention.

FIG. 7—is an exemplary diagram of progressive elaboration with incremental development, within which embodiments of the present invention may be practiced.

FIG. 8—is an exemplary workflow of a method in accordance with the claims.

FIG. 9 is an exemplary flow diagram involving plural functionalities according to diverse embodiments of the invention.

FIG. 10 is a workflow illustrating an exemplary system orchestration of stages with knowledge domains according to a plurality of embodiments of the invention.

FIG. 11 is a flowchart of an exemplary change management subsystem according to embodiments of the present invention.

FIG. 12 is a flowchart depicting web services and data reporting according to the invention.

FIG. 13 is a snapshot of the exemplary WBS work area, for an active project according to the invention.

FIG. 14 is a snapshot of exemplary printing services of the active project according to the invention.

### DETAILED DESCRIPTION OF THE INVENTION

In the following detailed description of exemplary embodiments of the invention, reference is made to the accompanying drawings which form a part hereof and in which is shown, by way of illustration, specific exemplary embodiments in which the invention may be practiced. These embodiments are described in sufficient detail to enable those skilled in the art to practice the invention and it is to be understood that other embodiments may be utilized and that logical, procedural, graphical user interface (“GUI”) and other changes may be made without departing from the spirit or scope of the present invention. The following detailed description is, therefore, not to be taken in a limiting sense.

Definitions:

Throughout this application, reference will be made to objects that are created or instantiated by computer software. Such objects will have a data portion associated therewith for storing information, and have methods or functionality associated therewith for providing the desired functionality to a client, accessing the object to manipulate the object's data.

As used herein, the term objects refers to software objects pertaining to a binary object model and that have binary extensibility through wrapping. Furthermore, such objects are interface-based, meaning that an object can be used or operated through specific interfaces, as defined hereafter, and an interface-based binary object model will entail objects having multiple interfaces. In this sense, an object is exposed through its interface. An object is a code-based abstraction of real-world entity or relationship. For instance, a CUSTOMER object that represents a real-world customer, such as customer number 123, or a FILE object that represents C:\config.sys on your computer hard drive.

As used herein, the term interface refers to a specification for a particular and related subgroup of behavior and properties. Behavior or methods are typically a set of software subroutines, with each subroutine having a signature made up of the arguments, their order, and their data type. Further, each interface will have data associated therewith in the form of properties that are only accessible through a subroutine of the interface. Finally, an object may support multiple interfaces to thereby allow an object's characteristics to be defined by the interfaces that it supports, and allow many classes to share behavior by supporting some of the same interfaces. A client application can treat the object like a black box, accessible only through its interface.

As used herein, the term class refers to a definition for directing a CPU to create an instance of an object. A class, therefore, will implement the interfaces that make up a given object, and therefore, is a template for creating objects. A class may be a source code definition that is compiled into executable code that will create run-time storage for the properties of an object and executable code to support the interface methods. A class is the code that defines an object and all objects are created based upon a class. A class is an abstraction of a real-world concept, and it provides the basis from which you create instances of specific objects. For example, in order to have a CUSTOMER object representing customer number 123, first a CUSTOMER class must exits that contain all of the coded methods, properties, events, variables, and so on, necessary to create CUSTOMER objects. Based on that class, you can create any number of objects, each one an instance of the class. Each object is identical to the others, except that it may contain different data.

As used herein, the term collection refers to a special variant for a kind of property. More specifically, it is a set-valued property meaning that multiple items are formed into a collection. An item includes, but is not limited to, scalar values such as integers, strings, etc., or may be an object (e.g. a handle to an interface of an object).

As used herein, the term component is used in the sense of a piece or part of the overall solution, this includes compiled software components, such as Microsoft .Net© assemblies and other artifacts such as Web pages or any component of the invention.

As used herein, a project profile is a collection of customized process preferences for the Project Life Cycle of the currently active project.

As used herein, when referring to loading a class means as in response to an event-driven method such as clicking a menu item or a tool in a toolbar or an item in a contextual menu.

The advantages of Multi-Tier Client/Server architectures include: changes to the user interface or to the application logic are largely independent from one another, allowing the application to evolve easily to meet new requirements; network bottlenecks are minimized because the application layer does not transmit extra data to the client, only what is needed to handle a task; when business logic changes are required, only the server has to be updated; the client is insulated from data base and network operations; and the client can access data easily and quickly without having to know where data is or how many servers are on the system.

N-Tier computing, in the context of distributed processing, accomplishes a synergistic combination of computing models, by providing centralized common services in a distributed environment.

This multi-level distributed architecture employs a back-end host of some kind (mainframe, UNIX device, computer, and data base/LAN server), an intelligent client, and one or more intelligent agents in the middle, controlling such activities as transaction monitoring, classic On-Line Transaction Processing (OLTP), security, message handling and object store control. This architecture typically leans heavily upon object oriented methodologies, to effect as much flexibility and interchangeability as possible.

Hardware and Operating Environment:

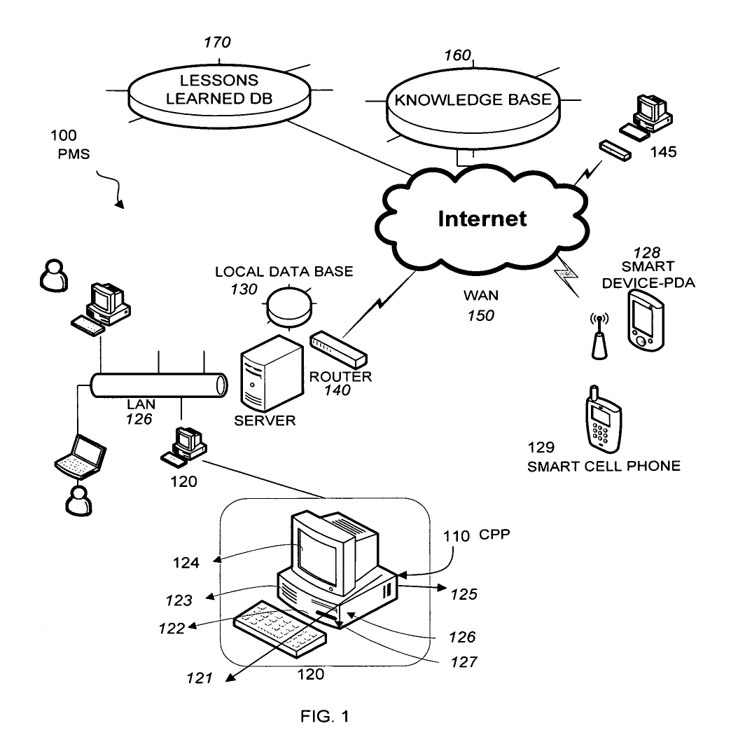

FIG. 1 is a diagram of the hardware and operating environment, in conjunction with which embodiments of the invention may be practiced. The description of FIG. 1 is intended to provide a brief, general description of suitable computer configuration, and topology, and a suitable computing environment, in conjunction with which the invention 100 may be implemented. Although not required, the invention is described in the general context of computer-executable instructions, such as program modules being executed by a computer, i.e. a personal computer. Generally, program modules include routines, programs, objects, components, data structures, class library, etc. that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention 100 may also be practiced in distributed computing environments, where tasks are performed by remote processing devices that are linked through a communications network. In a distributed computing environment, program modules may be located in both local and remote memory storage devices, which is the case of the Web Services referred to later on.

The exemplary hardware and operating environment of FIG. 1 for implementing the invention 100, includes a general purpose-computing device in the form of a computer 120, including a processing unit 121, and a system memory 122, a video display screen 124, and a system bus 125 (inside the motherboard) that operatively couples various system components, including the system memory, to the processing unit 121. There may be only one, or there may be more than one processing unit 121, such that the processor of computer 120 comprises a single central-processing unit (CPU), or a plurality of processing units, commonly referred to as a parallel processing environment. The computer 120 may be a conventional computer, a distributed computer, or any other type of computer containing the program 110; the invention is not limited.

The system memory may also be referred to as simply the memory, and includes read only memory (ROM inside on the motherboard), not shown, and random access memory (RAM) 122. The computer 120 further includes a hard disk drive 123 for reading from and writing to a hard disk, a magnetic disk drive 127 for reading from or writing to a removable magnetic disk, and an optical disk drive 126 for reading from or writing to a removable optical disk such as a CD ROM or DVD or other optical media.

The hard disk drive 123, magnetic disk drive 127, and optical disk drive 126 are connected to the system bus by their respective interfaces. The drives, and their associated computer-readable media, provide nonvolatile storage of computer-readable instructions, data structures, program modules, classes and other data for the computer 120. It should be appreciated, by those skilled in the art, that any type of computer-readable media which can store data that is accessible by a computer, such as flash memory cards, digital video disks, random access memories (RAMs), read only memories (ROMs), and the like, may be used in the exemplary operating environment.

The computer 120 may operate in a networked environment using logical connections to one or more remote computers, such as a remote computer 145. These logical connections are achieved by a communication device coupled to or a part of the computer 120; the invention is not limited to a particular type of communications device. The remote computer 145 may be another computer, a server, a router, a network PC, a client, or other common network node, and typically includes many or all of the elements described above relative to the computer 120. The logical connections depicted in FIG. 1 include a local-area network (LAN) 126 and a wide-area network (WAN) 150. Such networking environments are commonplace in offices, enterprise-wide computer networks, intranets and the internet.

When used in a LAN-networking environment, the computer 120 is connected to the local network 26 through a network interface or adapter that could be wireless or wired, which is one communications device. When used in a WAN-networking environment, the computer 120 typically includes a Router 140, a type of communications device, or any other type of communications device for establishing communications over the wide area network 150, such as the internet to gain access to the Lesson Learned Data Base 170, or the Knowledge Base 160. In a networked environment, program modules depicted relative to the personal computer 120, or portions thereof, may be stored in the remote memory storage device, Smart device-PDA 128, or Smart Cell Phone 129. It is appreciated that the network connections shown are exemplary and other means of, and communications devices for, establishing a communications link between the computers may be used.

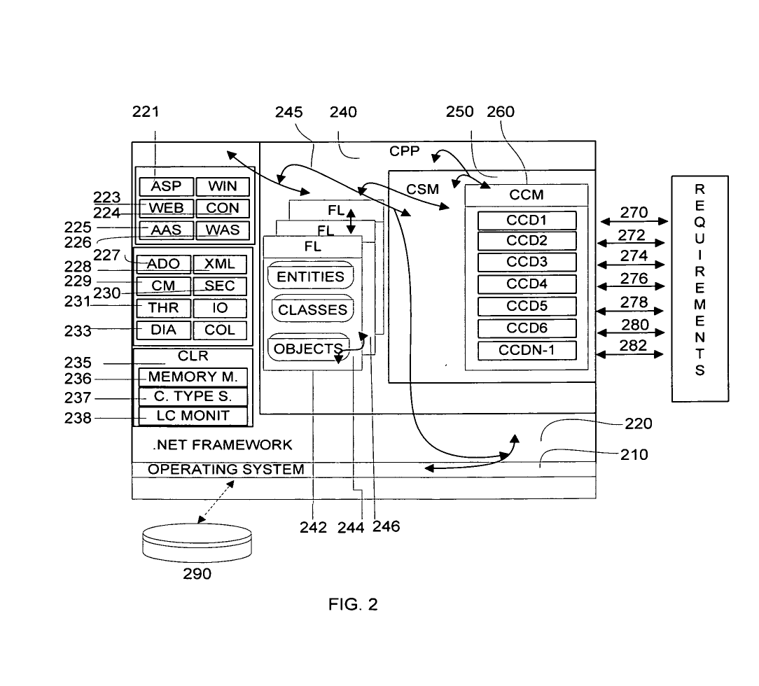

FIG. 2 is a schematic illustration for integration and orchestration of plural PM classes, entities and objects, with functional layers and OOT to provide PM services and processes.

At block 240, the invention provides the computer program product in accordance with the claims, comprising the block 250 for computer storage medium and the embedded block 260 for computer program code mechanism, for the general orchestration and integration in N-tier client/server, with functional layers represented by blocks 242, 244 and 246 respectively.

The block 240, the computer program product, is supported by block 220 representing the .Net framework 2.0, provider of plural services and technologies, and in the upper layer comprising: block 221 for ASP, block 220 representing Windows©, block 223 representing Web Services, block 224 representing Windows© controls, block 225 representing ASP application services and block 226 representing Windows© application services.

In the middle layer, block 227 represents ADO.NET, block 228 represents XML, blocks 229, 230, 231 and 233 respectively represent: component model, security, threading, input/output, diagnostic and collections.

In the lower layer the block 235 represents the common language run time, block 236 represents memory management, block 237 represents common type systems and finally block 238 represents lifecycle monitoring.

What the .Net framework does, is to wrap the operating system and insulate the invention from most operating system specifics, such as file handling and memory allocation, supporting a complete version of Windows©: Windows 2003©, Windows XP©, Windows Vista©, all versions of Windows 2000© and Windows NT©. In the case of said Web Services, SOAP is used to communicate over the internet. Other, but not less important, services of the framework are the deployment, scalability, metadata and XML dataset serialization, SQL Servicer 2005© features, NET providers: SQL server, Oracle.NET Data Provider and OLEDB.

At blocks 270 through 282 inclusive, the invention provides the computer code devices for functionalities in answer to PM requirements from the real world, which are described extensively in this application and appear in the claims.

At block 210, the invention shows the operating system, which can be one of the aforementioned.

At block 290, the invention provides the data storage, which can be either local or remote.

At block 245, the arrows represent the integration and orchestration of the aforementioned objects with PM classes and entities to provide a cohesive PM system.

System Level Overview:

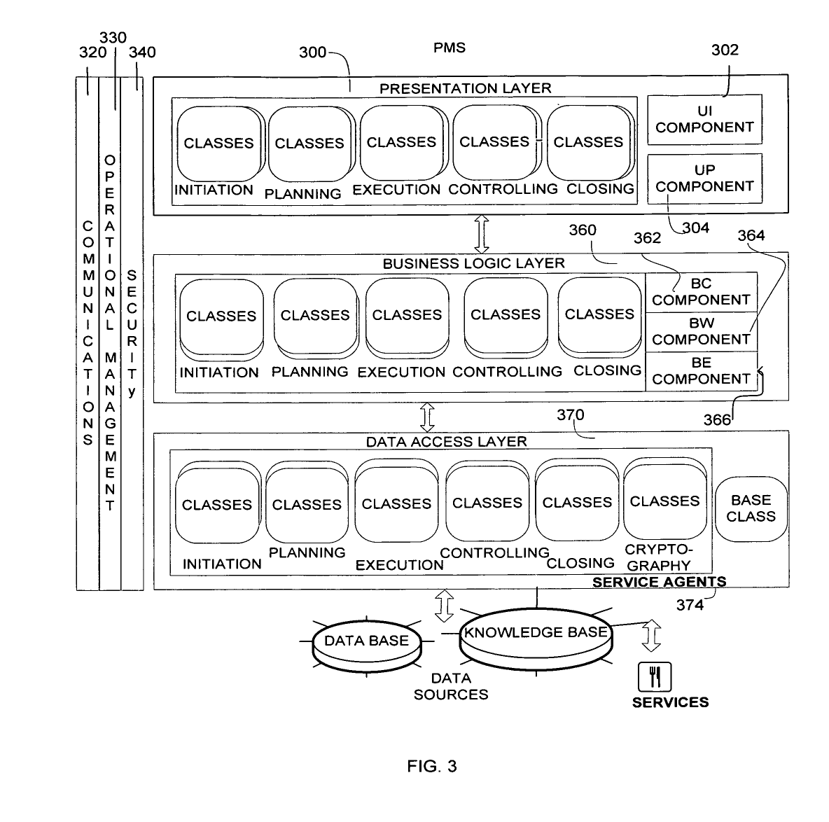

A system level overview of the operation of an exemplary embodiment of the invention 100 is described by reference to FIG. 3. The concepts of the invention are described as operating in a topology, as described in FIG. 1, and in a computer, such as computer 120 in FIG. 1. The exemplary operating environment of FIG. 3 comprises the layered architecture of the invention, to materialize all the advantages and flexibilities using .NET 2.0, and over a C/S N-tier approach, to provide a complete and global Solution for PM, with embedded best practices and event-driven methods.

In FIG. 3, the Presentation layer 300 is comprised of a user interface component 302, which is implemented with Windows© forms from .Net 2.0 and/or Microsoft ASP.Net pages, controls, and third party components, such as Infragistics NetAdvantage 7.0, used to render and format data for user interaction, and to acquire and validate data coming from the real world. There are many class forms to support every stage of a project lifecycle, and within them, every possible process as mentioned in the PMBOK© 2004, which are activated in concordance with the currently active project configuration profile.

At block 304, there are user process components to support the predictable group of processes, such as: selecting options or choosing alternatives from a list. In addition, there are classes for supporting specific presentation services, such as: graphics, charts and views, or video files for training purposes with visual and audio support. The versatility provided in the Presentation layer is a fundamental advantage in event-driven visual solutions, and the invention provides an uncommon versatility for this purpose.

The Business Logic layer 360 is comprised of business components 362. Regardless of whether the business process consists of a single step or a workflow, the business components 362 implement the business rules in the system. Business workflow components 364, are used to perform processes such as the Project Configuration Profile in the Project Management Plan Development module, which is one embodiment of the present invention, and where it is possible to configure the managerial scope, of the currently active project, as a collection of processes which is the responsibility of the Project Team or the Project Manager.

Business entities components 366 convey information between components. The business entities that are used internally in the system are generally data structures (datasets, schemas, constraints, data readers, or XML streams), but in some cases are custom-oriented classes such as: phases, deliverables, work packages and so on.

The Business Logic layer 360 is broken down into individual classes that relate to the major functions of the invention and are present in a project lifecycle, comprising groups of: business case (not shown), initiating, planning, execution, controlling and closing stages and the constituent processes for each said stage as the PMBOK© 2004 suggests.

At block 370, the Data Access layer allows access to data store (data base, files, arrays and others) comprising means and methods (OOT) for creating, retrieving, inserting, updating and deleting entity details, in a persistent manner, respecting and preserving: relationships, hierarchies, properties, referential integrity rules and constraints (i.e. Risk Register attributes, Integrated Change Management System attributes). This component abstracts the logic required to encrypt/decrypt data for the computer/server registry entry necessary to communicated and store data base credentials to the solution, having hashing and cryptographies technologies. This layer has a base class from which classes in the Data Access component inherit the aforementioned functionalities over different stages.

Like the Business Logic layer 360, the Data Access layer 370 is broken down into individual classes that related to the major functions of the invention and are presented in a project lifecycle, comprised of groups of: business case (not shown), initiating, planning, executing, controlling and closing stages, and the constituent processes for each said stage, and other service classes. There is a perfect match between the number and name-purpose of the classes in both layers: Business Logic and Data Access, being the classes correlated with the functional services.

Service Agent 374 represents the means for requesting functionality of external services, isolating the idiosyncrasies of calling diverse services.

Security Policy 340 is used as means for authentication. There are authentication methods at the Presentation Layer 300 and Dada Access layer 370. Another means used for security is authorization (permissions and rights) by roles.

Secure Socket Layer 320 is the approach to secure communications with signature in the Message (for securing data). Another technique implemented is the SOAP encryption mechanism.

At block 330, Operational Management implements: exception management in every layer, and monitoring and configuration are complementary techniques used with 330.

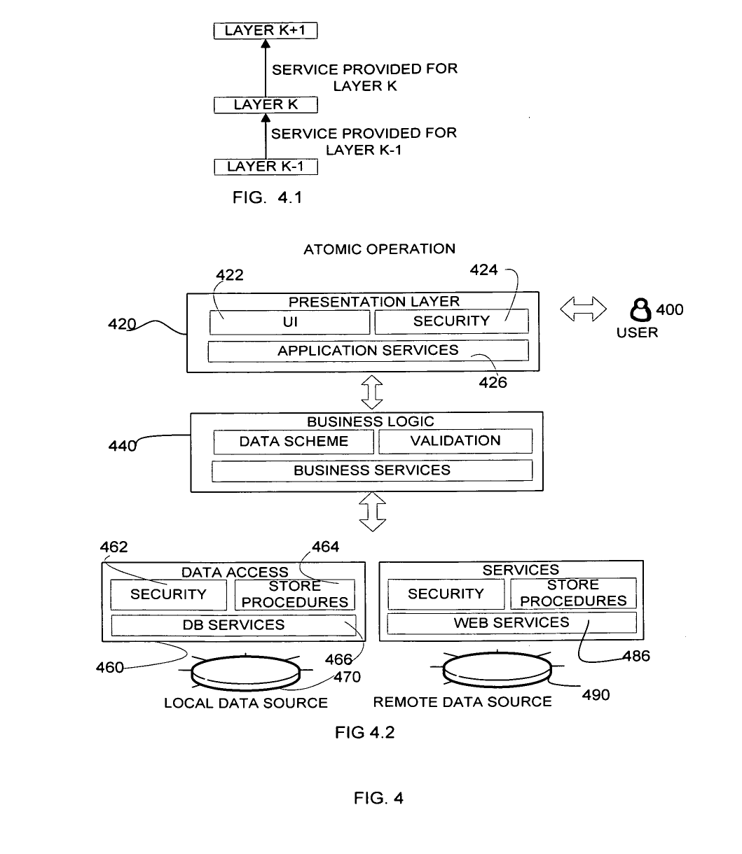

FIG. 4.1, represents the concept of layered service paradigm, in accordance with one embodiment of the present invention, where a Layer k provides services to the requesting Layer k+1, conversely Layer k−1 provides services to the Layer k. In the case of the present invention, the same concept is applied, but for a more complex structure of layers as FIG. 4.2 depicts.

As FIG. 4.2 depicts, the approach named Atomic Operations will be referred to as the means comprising object-oriented/event-driven methods requested by user intervention 400, soliciting Presentation layer 420 services through the dialogue with User interface 422, which in turns call security services 424 for authentication and verification of roles. Presentation layer 420 solicits services from Business Logic 440, which may return a data schema or call Business Services 446, or solicit services by means of execution of methods for a particular class library representing an entity, said class: i.e. Business Case invoking the corresponding method: i.e. using namespace.objectsignature (parameter, parameter), Do Something, such as, get Business Case. Business Logic block 440, in turn retrieves Data Access 460, which uses Security 462 for encryption/decryption and authentication credentials, calls data base services 466, which triggers store procedure 464 in order to retrieve data or manipulate it. Local Data Source 470 or Remote Data Source 490 can answer sending a dataset back that travels all the way up through the Business Logic layer 440 and arrives at the Presentation layer 420, and presents data requested (i.e. Business Case data in User Interface 422), end using.

The classes in the invention implement IDisposible interface, and therefore have an overload constructor with a signature f (string, string) where parameter 1 and parameter 2 are security parameters to be encrypted, and a destructor called Dispose. This enables the use of a class in a block: “using . . . end using”. After block Security 462, in Data Access 460, retrieves decrypted credentials, data base service 466 establishes a data base connection, the store procedure 464 triggers the corresponding data source for execution of the store procedure and fills the dataset with the results of the store procedure matching the data scheme in the Dataset, and Data base services 460 closes the connection, and from this moment the data connection is closed providing a greater degree of versatility.

When travelling to the Presentation layer 420, the dataset is validated in the Business Logic, and if it is the case, converts nulls to a zero length string which is sent to the Presentation layer 420 through the User Interface 422, in the format and in the corresponding component of the active class form (client) 422. The user is not aware of the method and processes required to provide or manipulate information, the results are just utilized. In this way, the requested information is presented to the user/team member/customer as if it were a one-step process, executed by Atomic Operations. This approach is valid for web services. In one Windows© form class or Web form class, there is enough code behind the scenes to support the functionalities that the invention, in the art of PM, provides.

FIG. 5 depicts an exemplary schematic diagram of a Project Configuration Profile, within which embodiments of the present invention may be practiced. Planning Stage processes 520 are provided as alternative choices, Execution Stage processes 540 are provide as selectable options, Control Stage processes 560 are presented for selection, and Closing Stage processes are available for the same purpose. Care should be taken when configuring the project profile because this limits the managerial capabilities in the currently active project. It must be noted that it is not possible to select a process, whose requisite has not been selected. This means that, i.e. it is not possible to select Quantitative Risk Analysis if the corresponding Risk Identification or Qualitative Risk Analysis has not been previously selected.

At block 530, requesting a particular configuration means checking in a checked hierarchical node tree 550, where processes by knowledge domain are contained and which in turn is the basis for creating a Data Structure 595. In a persisted way, by means of executing methods and processes of 590, when this happens, the access to menu items, toolbar items, or navigational bar items, change status from enabled to disabled, or vice versa. It should be noted that not all the processes that belong to a particular stage are selectable options. There are processes that are required; otherwise the invention fails the definition of project. Generally the processes that are selectable comprise the knowledge domains of: Quality, Risk, Procurement, Communication, Human Resources and Integration in diverse stages.

Work Breakdown Structure:

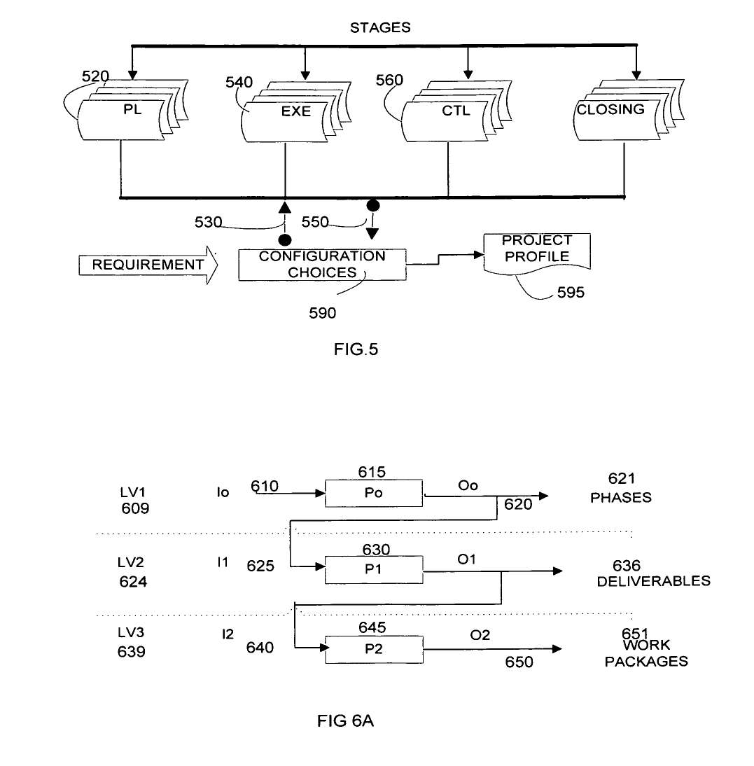

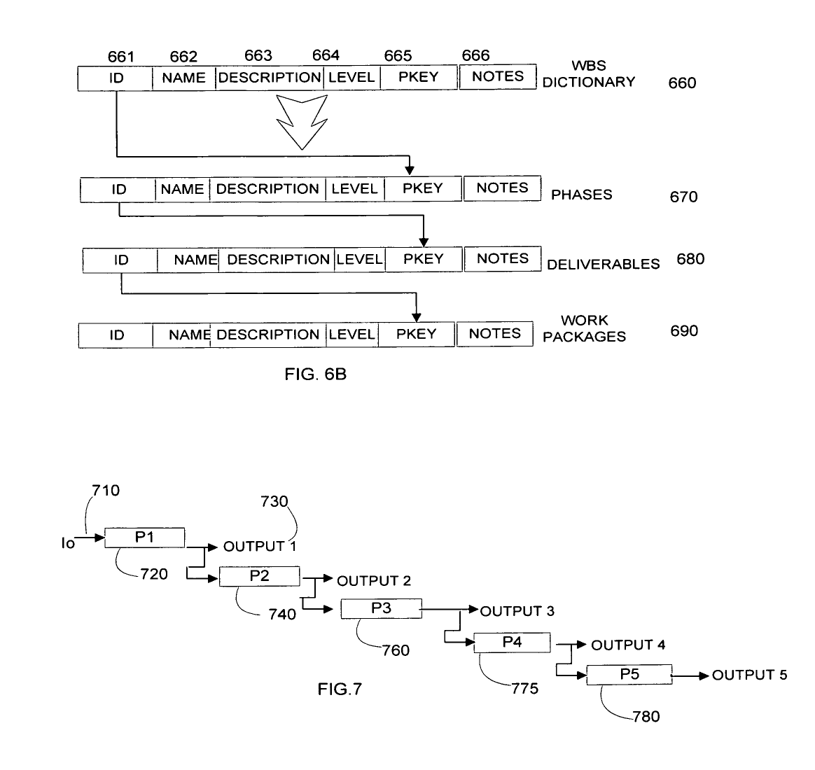

FIG. 6a depicts an exemplary schematic illustration of the WBS with hierarchical dependencies and relationships, within which embodiments of the invention may be practiced. Start with the input Io 610 in Level 1 609, representing the Scope Statement for the active project which will be the working material for this process. After being transformed by the Phases generator 615 Po, the output 620 for the Phases 621 is produced for the currently active project. This process could support maintenance, meaning that it can be modified, updated, reworked.

At 624 Level 2, there is a Deliverables Generator 630 P1, which has as input the Phases 625, resulting from the previous process. This Deliverables Generator 630 produces Deliverables 636 which are children of the Active Phase.

At 639 Level 3, we have a Work Packages Generator 645, that in turn takes input 640 which is a particular Deliverable and generates Work Packages 650 for the specific Deliverable 640. These Work Packages 651 have parent-child relationships with the Deliverables 636. These processes can be iterated; the result is a hierarchical tree with strong parent-child relationships that assure that every entity is a genuine element of the project, because it is over these objects that most of the processes described apply, indubitably.

FIG. 6b depicts a schematic diagram of the Data Structure of the elements generated by the WBS. In the first place, it is possible to recognize the collection of elements 660 which conforms what is called the WBS Dictionary, which will be manipulated to generate record or data rows for the object according to the corresponding level. The ID field is at 661, the Name field at 662, the Description field at 663, the Level field at 664, the Pkey or Parent Key field at 665, and at 666 there is a field for notes. By manipulating the WBS Dictionary the other objects are obtained. 670 represents a data structure for phases, 680 represents a data structure for deliverables and 690 a data structure for work packages, these entities have identical Data Schemas comprising: ID, name, description, level, Pkey and notes fields. It should be noted that the field Pkey is the key for establishing parent-child relationships, basically one-to-many. It is important to recognize that the WBS and its structure enable, by design, structured Gantt charts for diverse WBS levels, tracking diverse managerial categories. For the reasons mentioned, the WBS is a graphical communication tool that conveys consolidated information about the project scope, by means of discrete elements perfectly specified, with strong entity relationships. This is a fundamental difference with prior art because it is only through the WBS that it is possible to introduce activities into the system.

FIG. 7 is an exemplary diagram of progressive elaboration with incremental development, within which embodiments of the present invention may be practiced, and which for convenience and objectivity it will be exposed with an exemplary Schedule Development process, but this is not a restriction or a limitation of the invention. For instance, this could be done for the risk, procurement or communications domains.

After elaborating the WBS, the next logical process in that domain is the Activity Definition Process which means to generate activities to perform the Work Packages for that purpose. Io represents a Work Package 710, which is input to the 720 Activity Definition P1. In this process, after generating the activities that belong to the current Work Package, it is possible to submit information relating to: duration attribute, sequence order attribute, precedence attribute, relationship type attribute, begin attribute and others. As a result, it is possible to have a weighted Work Package in the time domain, but since the Work Package belongs to a specific Deliverable and this Deliverable is part of the Phase/Stage entity. It is possible to obtain a timeline of the active project by just clicking the corresponding tab. In this way, we obtain an estimation of the duration of each Work Package, each Deliverable, and the corresponding Phase. The start day is today. By the same token, output 730 is an activity that is the input of the next 740 process P2, which is Activity Sequencing. At this opportunity, the verification and validation of the attributes of the previous process are enabled. In this sense, the timeline obtained is validated by checking the sequence and the time accumulation at the Work Package level, which is a transferable behavior to the Deliverable and Phase levels, but this time with more precision. Using the same rational, we use the block 760 for Activity Resource Estimating. This process provides potential delay factors such as the availability of any kind of resources which can produce a change in the basic timeline; technically this is a potential risk that should be considered in a corresponding knowledge area.

At block 775, or Activity Duration Estimation, there are enough information elements to know the most probably duration of the currently active project. In addition, information is available relating to availability, suitability, efficiency ratio and the most importantly: probable involved cost. When arriving at the block Schedule Development 780, there is exact information in the time domain and in the cost domain. This means that information belonging to a particular process was known in advance, and this information was not an output of the current process but was incrementally developed and progressively elaborated. It is necessary to mention that the method for establishing the duration of Work Packages and Deliverables, represents an innovation or improvement on prior art, because is deals with discrete entities within a specific context, where there is no need to establish Critical Path or Network Diagramming methods. This is because, the WBS produces specific deliverable-oriented entities that are not mixed with activities that belong to the other domains. Another extreme improvement over prior art is that, at this point, there exists information belonging to the cost domain processes, in advance of the cost domain being developed. An estimate of the cost and estimated budget of the project already exists, at a Work Package level, performing time/schedule oriented processes, enabling, at the opportune moment, more precision for estimation purposes.

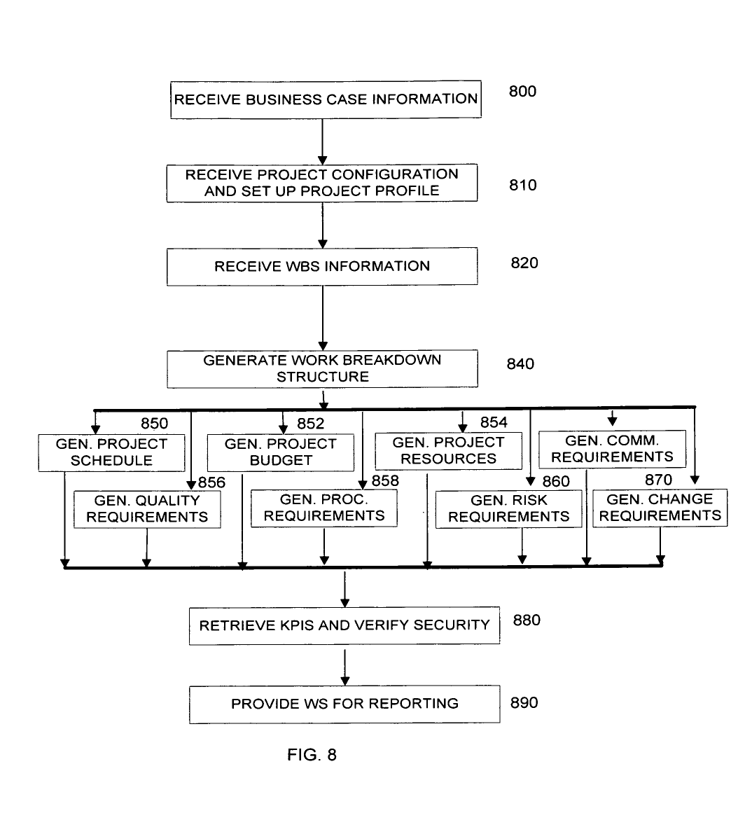

FIG. 8 is an exemplary workflow of a method in accordance with the claims.

At block 800, the method may open a Business Case based on the existence of a file containing security encrypted credentials. This may be valid information; in that case the method authorizes the opening of the Charter and Preliminary Scope processes, which in turn allow the opening of the Scope Planning and Scope Definition processes, and finally the WBS GUI. If the method finds inconsistent or non-valid credentials it will try to generate a new object Business Case. Care must be taken to ensure that, at all times information relating to the credentials of the Projects is available in good standing.

At block 810, the method may configure a Project Profile with a selection of preferred processes to be performed by stage. This profile determines the actual managerial scope of the invention for a particular project, which allows selection of just the quantity of necessary processes in concordance with the current project's complexities. Care should be taken with selection of required processes; otherwise the managerial capabilities become limited for that particular project, and can result increased risk to the project in question. Even though this step may be taken immediately after determining the Preliminary Scope of a project, it should be delayed until completion of the WBS, particularly in complex projects.

At block 820, the method collects information for elaborating the WBS, essentially this information comes from the Scope Statement for the currently active project.

At block 840, the method may generate a WBS if the input information is validated and with enough level of detail. The WBS is a hierarchical level structure with components comprising: Phases/Stages, Deliverables and Work Packages and the information necessary to generate the parent-child relationship with inheritance. The data structure of the components is identical for processing purposes.

At block 850, the method generates, by incremental development, the Project Schedule, which means integration and validation of outputs of predecessor processes, basically those that deal with the object's activity: definition, sequencing, resources, duration estimation.

At block 852, the method generates, by incremental development, the Project Budget, by means of integrating consolidated information from: Activity Resource Estimation, Activity Duration, Project Schedule and Budget Estimation. This is a roll up technique with several steps.

At block 854, the method may provide the project resources in terms of materials, equipment, services, labor and services, coming from other domains such as: Procurement, Quality, Risk and Communications, respectively, according to the specific project profile of the currently active project.

At block 856, the method may provide facilities for: Quality Control and/or Quality Assurance according to the specific project profile of the currently active project.

At block 858, the method may provide services of the Procurement domain, if they are part of the specific project profile of the currently active project.

At block 860, the method may provide support for Risk processes, in concordance with the specific project profile of the currently active project. This is another implementation of incremental development.

At block 870, the method may provide Change Management services by assessing the feasibility of the requirements in terms of resources and impact analysis.

and the term Key Performance Indicators (“KPI”) the Earned Value technique as mentioned in said PMBOK©

At block 880, the method may provide Key Performance Indicators (“KPI”) comprising: CV, SV, CPI, SPI, ETC, EAC, PV, AV and others using EV techniques and other analysis tools for collecting performance information, as may be selected as part of the specific project profile of the currently active project, in concordance with the Communications Planning processes. The information collected is made with the corresponding credential and validating and authenticating roles and security credentials in the different layers.

At block 890, the method may provide web services for reporting if the security conditions of block 880 are correct and the requester belongs to the corresponding interest group.

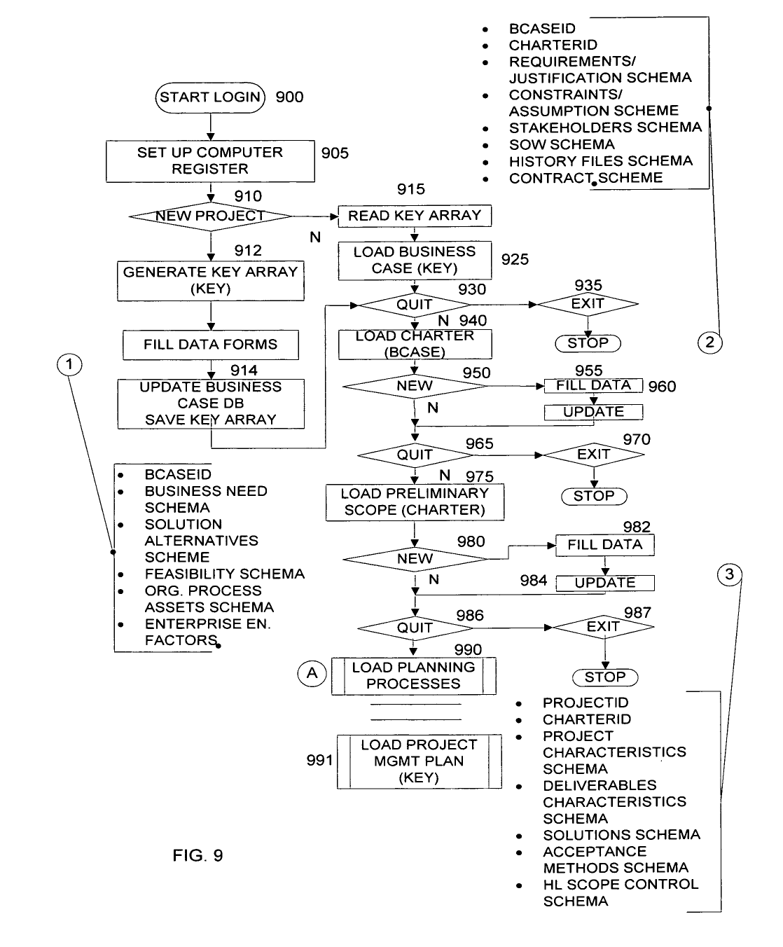

FIG. 9 is an exemplary flow diagram involving plural functionalities according to diverse embodiments of the invention.

At block 900, starting the system triggers the login process where the user identification, interest group and password are parameters to be validated, using security algorithms and cryptographic techniques. If the process ends normally, and in addition it is the first time that the system is executed, the next step is to set up the computer register, otherwise this step is skipped and the system proceeds to block 910.

At block 905, setting up the computer register involves invoking, from the main menu, the corresponding entry (security) to fill in the parameters that will be encrypted, using the corresponding class (system.security.cryptography). After this is executed, there is a call to the RegistryKey class to provide access to registry keys with write permission, for the LocalMachine root key, and the encrypted parameters relating to credentials are saved to the registry. Each time a class form is invoked; it will need part of the credentials, in order to be instantiated and loaded. This exemplary method is part of a security subsystem. It should be noted that, any time one object is encrypted, it is necessary to execute the reverse process in order to use it.

At block 910, depending on whether a business case exists or not, a facility is enabled to open it for operational purposes.

At block 912, as a consequence of there being no Business Case, the system suggests it be generated (this is the first time using the system or a credentials file is corrupted, and in that case the invention sends an exception message.) In an automatic way, an empty Business Case class form is loaded and a few parameters, of type Guid, are generated. Windows® style forms are enabled to provide information of data activities comprising entities of: business need, solution alternatives, feasibility parameters, organizational process assets and enterprise factors.

At block 914, using the corresponding methods and Atomic Operations, the key and Business Case information are generated, as a file, and in the corresponding Data Storage with the data schemas created for this purpose.

At block 915, a Project file exists and the key array is loaded and verified.

At block 925, an overload constructor is invoked, to load the Business Case form with recovered credentials, and present information in the corresponding form class, and afterwards execute a request for information with credential for the data base. Care should be taken, at every moment, to preserve the corresponding keys in good standing, because of the extreme security measures it takes to recover information or to load a class form.

At block 930, exists an option to quit the system process.

At block 935, exists an option to leave the system, with a warning confirmation message regarding the persistency of the intention.

At block 940, an attempt is made to load the Charter class form.

At block 950, if a Charter object does not exist, a suggestion is made to create one by loading an empty Charter class form with a data schema for topics comprising: stakeholders, requirements/justifications, constraints/assumption, statement of work, history file and contract entities, which are enabled for filling with appropriate data 955, and updating the data base with Atomic Operations 960. It should be noted that, previously the key of the corresponding Business Case has been associated to the said Charter class.

At block 950, when a Charter object exists, it is because it has been validated with the corresponding Business Case Key. In other words, a Charter is loaded with the key of the corresponding Business Case parent.

At block 965, exists a quit option.

At block 970, exists a system exit option.

At block 975, using an overload constructor and verifying that the parent (Charter) key exists, the class form is loaded creating a GUI for topics comprising: project characteristics, deliverable characteristics, solutions, acceptance methods and high level scope control entities.

At block 982, the Preliminary Scope object does not exist, and the facilities, with the characteristics and data schemas mentioned in block 975, are provided. 980 means that Preliminary Scope object does exist.

At block 984, using Atomic Operations the data base for the corresponding table is updated.

At block 986, there is exists an option to quit.

At block 987, the option to exit the system is available.

At block 990, the possibility, is enabled, to load: the overload constructor class forms in the Planning stage for ever domain, and the corresponding facilities, to create or updated the corresponding entity with information pertinent to its purpose.

At block 991, the Project Management Plan loaded with an overload constructed is enabled, having as its Key the Project Key. It should be noted that from this moment and throughout all other stages and processes, the Project Key is a necessary parameter.

The idiosyncrasies mentioned for this exemplary process are applied for other processes; consequently, the content varies according to the purpose of the process and each class form will have: corresponding support at a data scheme level, classes, security and reporting capabilities, and which will be mentioned herein.

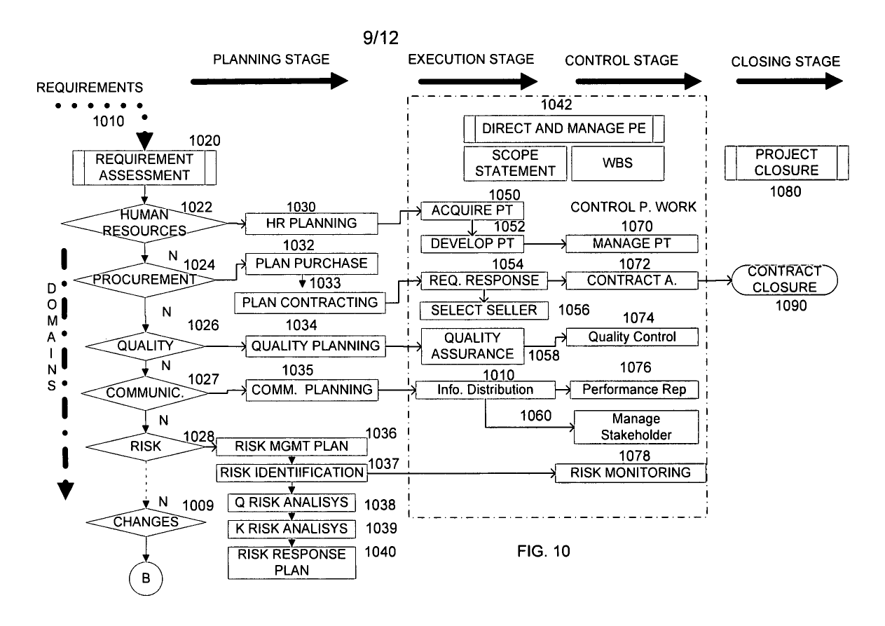

FIG. 10 is a workflow illustrating an exemplary system orchestration of stages and knowledge domains according to a plurality of embodiments of the invention. It should be noted, that it is implicit that the corresponding Project profile exists and matches the selected process for which the description will be made. The big diagram shows requirements for knowledge domains according to stages. The second approach is assessing the requirements identifying the stage, and the implicit sequence. For objectivity, all the processes will be described, but this does not mean that the invention requires that these processes have to be performed for every project. As it has been previously stated, it is the Project profile configuration that contains the required processes.

At block 1020, the requirement assessment is performed according to requirements 1010.

At block 1022, Human Resources is enabled if it is the selected domain.

At block 1030, Human Resource Planning is enabled in the corresponding stage, facilitating the GUI and Data schemes necessary for collecting information comprising: project roles, responsibilities and reporting relationships, and the Staffing Management Plan, comprised of: Staff Acquisition timetable, training needs, and recognition and rewards. This is an information collecting interface that produces the Human Resource Planning objects which are the governing rules for Human Resource entities. It should be noted that this interface contains previously mentioned objects and entities (i.e. role is a category for stakeholders in the Charter class form). This is, again, the application of incremental development and progressive elaboration across the invention and is part of the whole orchestration.

At block 1050, continuing within the same domain, we have the interface Acquire Project Team, which follows the business rules defined at block 1020, but this time in a different stage, the Execution stage. In consequence, what is shown is an interface for the currently active project, with Humane Resource requirements and details relating to: role, requirement date, to, request date, modality, and others. This class inherits characteristics assigned to the role description. At this point, there are fields, for introducing information related to the recruiting process of the Human Resources domain, needed for all the contractual relationships.

At block 1052, and within the same stage of Execution, the interface for Develop Project Team is enabled, for the currently active project. This interface provides the means, as a class component, to present the list of actual Human Resources, with fitting capabilities for the Roles field, in a data adequate grid component for this purpose; and where it is possible to identify needs for training, needs for new skills and issues log. Contractual means provide functionality for the data manipulation, using Atomic Operations, and printing and publishing capabilities.

At block 1024, Procurement is enabled if this is the selected domain.

At block 1032, Plan Purchase is enabled, facilitating the interface necessary to select the business rules for acquisitions, fundamentally those of materials, equipment and services related to the Work Packages that are part of the WBS for the Planning stages; and comprising means for inserting the information related to Make or Buy Analysis, and the Procurement Management Plan. In function of the information produced in the Activity Resource Estimation and Budget, it is possible to generate decisions relating to said Make or Buy Analysis and to obtain the list of potential suppliers.

At block 1054, Request Response is the process that requests quotes from prospective sellers that have been registered in its opportunity. It should be noted that, it is in this process where it is possible to categorize an acquisition under the modality of contract, which will be material for a subsequence process. As it is probably known, a contract is a manner or approach that transfers risk. This means that Contract Statement is an integral part, or a root cause for risk. In other words: a contract implies a risk that needs to be assessed. Obviously, as it possible to imagine, suppliers can be categorized by product, producing a ranking based on ratios or score cards. It should be noted that, this process contains and collects information related to: procurement, metrics, technical specifications, economical offers of an Evaluation criteria, metrics for approach or strategy, timing, reputation and other factors that will be considered when it becomes necessary.

At block 1033, Plan Contracting is enabled, as a consequence of the results of block 1032 Plan Purchase, for those acquisitions under the modality of contracts. In this process the interface (GUI) provides support for inputting information to precise the legal aspects and documentation to be part of the contractual agreement between the seller and the buyer. The interface provides the means to select multiple choices according to the nature of the potential contract, to elaborate the documentation required for the specific procurement document, and by the same token, provide the evaluation criteria and a more granular detail of the Statement of Work introduced in the Charter. It should be noted that, what occurs here is to define the business rules that are tuned by incremental development.

At block 1054, Request Response is enabled. At this point, it is evident that, this is the place where integration of the Plan Purchase and requirements occurs. The interface facilitates graphical context for requesting bids, proposals or quotes, each having one respectively approach for communicating or advertizing. It should be noted that, this is the most important process for this stage, of this domain, in terms of elaboration and time consumption. It should be further noted that, fundamentally, the information requested is correlated with the evaluation criteria. In addition, this and the previous process make use of the technologies and approaches that have been described throughout this application, as an integral part of the invention.

At block 1056, Select Seller is enabled. This interface provides all the necessary facilities to qualify and make a scorecard classification for the bidders and potential contractors. There are cases where, only a best offer is necessary for assigning the responsibility to a supplier. In the case of contract, the contractual/legal aspect is a core issue. Information related to technical specifications, penalties and nature and description of deliverables was submitted as part of Request Response. For reasons of legal implications and associated risk, this information is an integral component in Contracts. The process and documentation at 1056 have another objective, and it is the Auditing Material category within the whole process, and the Lessons Learned that can take place. Care should be taken in filling in all information for this process, because it will be used in a subsequent process.

At block 1026, if the Quality domain is selected, 1034 is enabled, being the Quality Planning process for the Planning stage. This is likely the core differentiation with other techniques for Project Management, possibly because it involves a cost and demands ownership. For whatever reason, one of the motivational factors, in the broader sense, for this invention is the Quality domain and specifically Quality Planning.

At block 1034, in Quality Planning, the graphical interface renders the necessary objects to satisfy the collecting of Quality requirements in terms of: organizational requirements, quality metrics and customer satisfaction, as well as the Quality standards relevant to the currently active project. By the same token, it allows the Cost/Benefit analysis in terms of: less rework cost, higher productivity value, and incremental stakeholder satisfaction, to generate the ratio cost/benefit. The form class exposes graphical flexibility to collect and estimate: cost of conformance, cost of non-conformance, internal/external cost failure, and delivers the cost of Quality for the currently active profile. It must be noted that there is a section that collects information about the Process Improvement Plan. All these estimations are inputs to the budget, and care must be taken to omit them because without resources it is not possible to practice Quality.

At block 1058, Quality Assurance, the invention provides the means to manage the undertaking in the Quality Audit step, comprising: verifying the level of execution of the Quality Plan, tracking the Change Control satisfaction, and using a comprehensive system, like the invention, to assure that the best practices are applied for continuous process improvement. It is in this moment when the complete managerial approach is evaluated. Quality Assurance is embedded in the Deliverables, and is not a result to evaluate. By the same token, the invention allows a global review of all the constituent process and approaches used to manage a specific project.

At block 1027, if the Communications Domain is selected, Communications Planning is enabled, which is where the invention defines, in a concrete manner, information units and their characteristics comprising: type, frequency, media, responsible, restrictions, security, interest group, communications technology and others. The second object of interest, in this embodiment, is the information requirements by stakeholders, which is called information needs. With these entities, it is possible to determine who needs what, when, where and how, assigning responsibilities for each task. Care should be taken in registering all information requirements, because this process defines the business rules for the subsequent process in other stages of the same domain.

At block 1010, Information Distribution in the Execution stage, the invention provides the necessary facilities to deliver on time, the right information unit to the corresponding owner. It should be noted that, one of the most common failures in PM is the lack of a good Information Distribution System, which is an integral part of the Stakeholder Management process considered within the present invention. What is provided is comprised of methods and procedures to distribute, in concordance with the Communication Plan, Project records and Lessons Learned. These are the main topics that the invention supports. Again, progressive elaboration and incremental development are applied, for updating records of entities previously treated.

At block 1028, if the Risk domain is selected, the Risk Management Plan is enabled for: Define the Approach, Planning Risk and Conduction of Risk Management Activities. The Risk domain is an excellent example of progressive elaboration and incremental development, starting with the graphical interface for collecting information about process entity attributes where the main goal is to: assign a responsible owner, determine if it is possible to include a budget for the activities, and tracking approach. In the corresponding part, Planning Risk, there is an embodiment to configure risk categories based on: technical, organizational, external and PM categories. In addition, it is possible to define risk probability and risk impact over WBS derived entities and managerial activities in general. By the same token, room for register tracking risk processes has been considered, as well the condition of Risk Management activities. At this point of the description, it should be event, that the place where the business rules for all specific domains are defined is the corresponding management interface for the active domain.

At block 1037, Risk Identification is enabled. In this module, the invention provides means for generating and operating the Risk Register and the gathering techniques used to collect this information. It should be noted that this collection of information has another entry point, the Scope Definition Module, where probably an initial identification has been preformed and which is part of the general orchestration of the invention.

At block 1038, Qualitative Risk Analysis is enabled, providing facilities for: registering the probability of occurrence and the impact associated for each identified risk. In this way an assessment can be realized and a ranking elaborated. This process updates the Risk Register and provides a tool to determine if a subsequent quantitative assessment is required. In the practical application, simply identifying the risk is a good source for determining if more processing is required. It should be noted that this is a work-in-progress type process, and has to be iterated a few times according to specifics of a particular project.

At block 1039, Quantitative Risk Analysis is provided by the corresponding interface. Probably this is the process most often avoided because it is time consuming and requires an owner. The principal object to be processed according to the invention is the Risk Register, and the approach implements a decision tree over elements of the Risk Register, that consider WBS entries derived for expected monetary value techniques.

At block 1040, Risk Response Plan is enabled, providing graphical facilities for: Define Strategies, Structure the Risk Response for each risk identified and ranked, assessing the impact by the objective. Again the Risk Register is updated with the information collected in this opportunity.

At block 1042, Direct and Manage Project Execution is enabled, and at this moment, the integration and orchestration of PM processes with OOT is more evident, because it allows the amalgamation of all the techniques, with the currently active profile, in order to lead both product oriented and managerial activities in one direction, the project objectives of: scope, time, cost and quality. A few of the discrete processes in this module have been described in blocks: 1050, 1052, 1054, 1056, 1058 and 1010, under the direction of the corresponding management plans for each domain. It should be said that the PM art is an amalgamation of commitments with a plurality of domains. On one hand the product oriented activities derived from the WBS have been treated, and on the hand the managerial approach for the planning execution stages has been covered.

At block 1070, 1072, 1074, 1076, 1060 and 1078, the invention enables the interfaces comprising: Manage Project Team, Contract Administration, Quality Control, Performance Reporting, Manage Stakeholders and Risk Monitoring respectively, which are constituents of the Controlling stage, and basically deal with conformance and variations to the formal specifications, providing the feedback necessary to apply the corresponding corrective measures. In this context, the performance of Human Resources is reported, the conformance is determined in the case of Contract Administration, conformance and tolerance is assessed in Quality Control, all the accomplishments and effectiveness are considered in Performance Reporting where KPIs as a result of EV are computed and reported. By the same token, the issues log is updated for Manage Stakeholders and the permanent evolution and behavior of identified risk is performed in Risk Monitoring.

At block 1090, Contract Closure is enabled allowing the means for recording the conformance to specifications and contractual agreements for the signed contract, evaluating deliverables and emitting the conformity letters if that is the case, this, according to the Plan Procurement and Plan Contracting, respectively.

At block 1080, Project Closure is enabled facilitating the means for recording project files and administrative closure, comprising: formal acceptance documents and completion documents. This process takes a course of action through the diverse management plans elaborated for each domain.

At block 1009, Change Requirements are provided which will be explained in later on.

Although the foregoing workflow sets forth the detailed description of different embodiments, it should be understood that the scope of this patent is defined by the words of the claims set forth at the end of this patent. The detailed description is to be construed as exemplary only, and does not describe every possible embodiment, because describing every possible embodiment would be impractical, if not impossible.

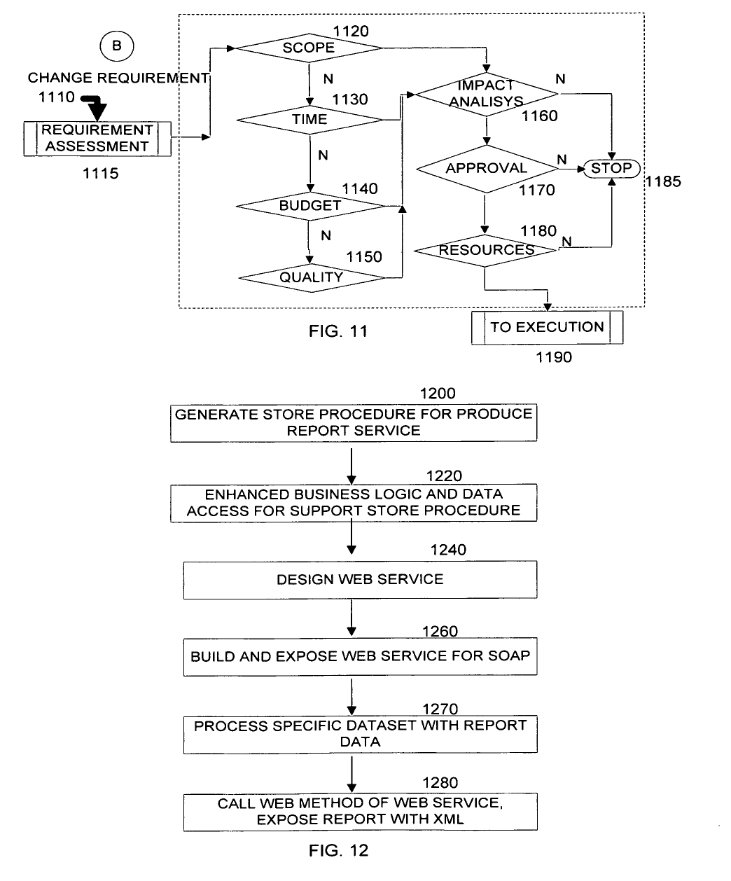

FIG. 11 is a flowchart for an exemplary Change Management subsystem according to embodiments of the present invention:

At block 1110, Change Requirements represent the active requirement being an input of the Change Management Subsystem.

At block 1115, Requirement Assessment is enabled.

At block 1120, Scope Domain Change is enabled.

At block 1130, Time Domain is enabled.

At block 1140, Budget (Cost) Domain is enabled.

At block 1150, Quality Domain is enabled.

At block 1160, Impact Analysis is enabled.

At block 1170, Authorization is enabled.

At block 1180, Resources Domain is enabled.

At block 1190, Execution is enabled.

At block 1185, the process is stopped.

FIG. 12 is a flowchart depicting web services and data reporting according to the invention.

At block 1200, a generated store procedure for producing report services is depicted.

At block 1220, enhanced business logic and data access for supporting the store procedure are depicted.

At block 1240, design web services is depicted.

At block 1260, build and expose web services for SOAP are depicted.

At block 1270, process specific dataset with report data is depicted.

At block 1280, call web method of web service and expose report with XML is depicted.

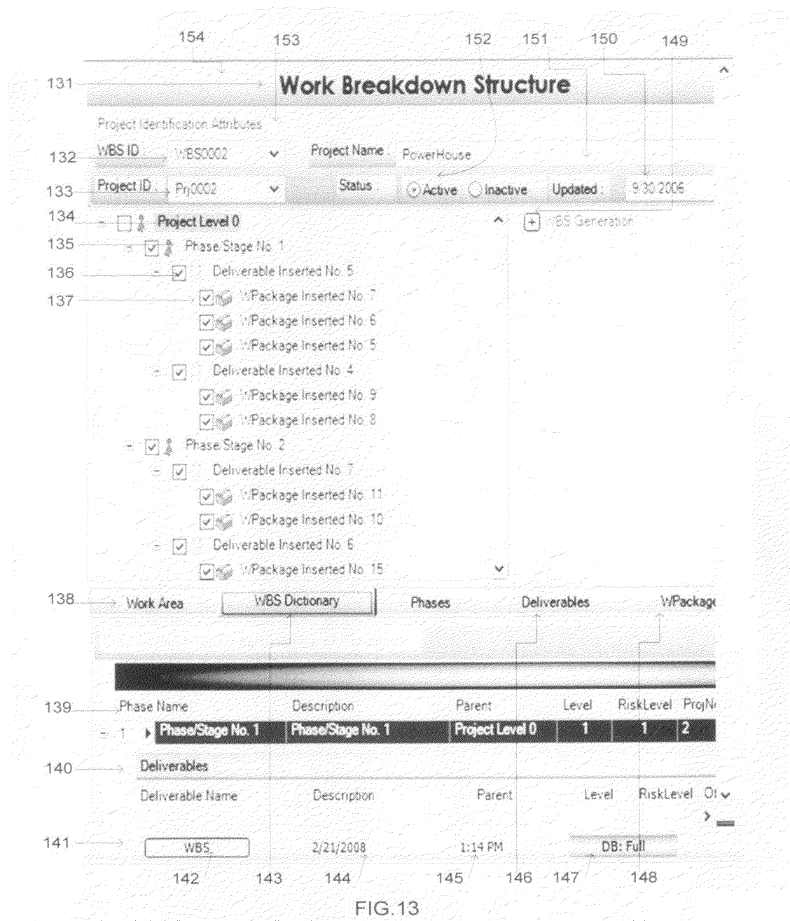

FIG. 13 is a snapshot of the exemplary WBS work area, for an active project according to the invention.

At block 131, a title of the work area is depicted.

At block 132, the WBS ID for the currently active project is depicted.

At block 133, the ID of the Project, is depicted.

At block 134, a hierarchical tree level 0, is depicted.

At block 135, a hierarchical tree Phase level, is depicted.

At block 136, a hierarchical tree Deliverable level, is depicted.

At block 137, a hierarchical tree Work Package level, is depicted.

At block 138, a tab: Work Area is depicted.

At block 139, a data grid view, Phase level, is depicted.

At block 140, a data grid view, Deliverable level, is depicted.

At block 141, a status bar is depicted.

At block 142, a Current Active Process in a status bar is depicted.

At block 143, a Tab: WBS Dictionary is depicted.

At block 144, a Date of Process is depicted.

At block 145, a Time of Process is depicted.

At block 146, a Tab: Deliverables is depicted.

At block 147, a Data base status is depicted.

At block 148, a tab WBS Work Packages is depicted.

At block 149, the WBS generator is depicted.

At block 150, the Update date is depicted.

At block 151, an Exemplary Project Name is depicted.

At block 152, the Process status is depicted.

At block 153, Project Identification attributes are depicted.

At block 154, a WBS Header is depicted.

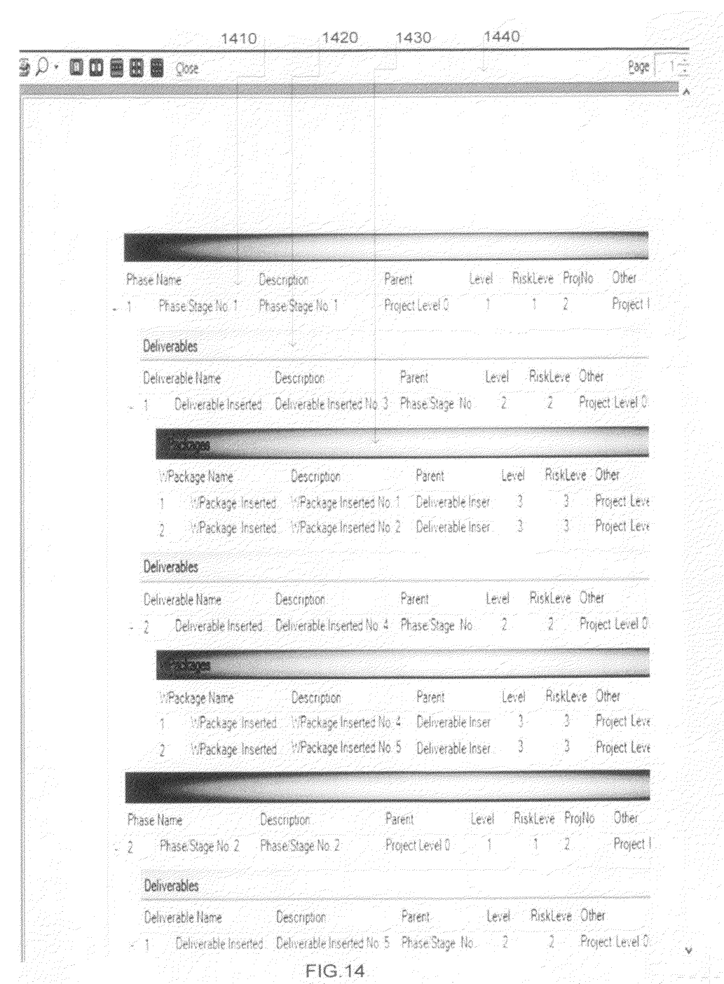

FIG. 14 is a snapshot of exemplary printing services of the active project according to the invention.

At block 1410, a WBS Data Dictionary, Phase Level, is depicted.

At block 1420, a WBS Data Dictionary, Deliverable Level, is depicted.

At block 1430, a WBS Data Dictionary, Work Package Level, is depicted.

At block 1440, a Print Toolbar is depicted.

Conclusion:

The PM Solution, architecture, methods, stages, processes entities and object have been described as an integral system, with incremental development and progressive elaboration throughout a project lifecycle. As those ordinarily skilled in the art will appreciate, the embodiments of the invention provide advantages not found in previous PM software systems. For example, there is no possibility to deal with a Work Package that is not created as a result of the WBS, and conversely there is no activity that does not belong to a Work Package. In this way there are no foreign objects in the system, this being a consequence of the embedded best practices in the solution, and the implementation of the incremental development approach. The invention is a managerial tool which enables a shared vision in the art of PM, within a corporation. Thus, the embodiments of the invention make more efficient use of both: stakes and project resources, than those of previous systems. In short, the invention empowers the project organization to make quality decisions, rapidly by means of managing, by enabling a performance management environment with consistent reporting on the metrics, ratios and activity drivers.

Furthermore, the embodiments of the invention operate in multiple configurations, stand alone, networking or on a global scope, connecting stakeholders throughout the collaborative processes.

Although specific embodiments have been illustrated and described herein, it will be appreciated by those ordinarily skilled in the art that any arrangement, which is calculated to achieve the same purpose, may be substituted for the specific embodiments shown. This application is intended to cover any adaptations or variations of the present invention.

For example, those ordinarily skilled in the art will appreciate that, while the current teaching deals with a N-tier Client/Server implementation, other means of providing functionality, such as Software on Demand, can be readily enabled. In addition, the embodiments of the invention have been described in terms of a one-project example. However, the systems and methods described can be applied to any project, in any field, serving a similar purpose. The terminology used in this application is meant to include all the environments mentioned as possible for the implementation. Therefore, it is manifestly intended that this invention be limited only by the following claims and equivalents thereof.

What I claim as my invention is:

1. A computer program product comprising: a computer storage medium and a computer program code mechanism, embedded in the computer storage medium for causing a computer to integrate and orchestrate in an N-tier Client/Server architecture, plural PM classes, objects and entities, the computer program code mechanism comprising: a first computer code device configured to receive project information related to a business case, from plural information sources; a second computer code device configured to receive project configuration information and to set up a real-time project profile of the currently active project; a third computer code device configured to produce a WBS; a fourth computer code device configured for progressive elaboration and incremental development over WBS entities, to deliver the: project schedule, project budget and project resources; a fifth computer code device configured to deliver project requirements of: quality, human resources, procurement, change, communication and risk domains respectively, for the active project profile; a sixth computer code device configured to retrieve and track real time KPIs, upon user request and on demand; a seventh code device configured to provide security and access control; and an eighth computer code device configured for web services.

2. The computer program product as claimed in claim 1, wherein the plural PM classes and object entities comprise a project life cycle of: business case, initiation, planning, execution, controlling and closing stages.

3. The computer program product as claimed in claim 2, wherein the initiation stage comprises: a project charter and preliminary scope objects.

4. The computer program product as claimed in claim 1, wherein the information relating to project configuration and setting up a real-time project profile, is the actual managerial capability of the active project throughout all stages.

5. The computer program product as claimed in claim 1, wherein the third computer code device comprises WBS objects and entities and parent-child relationships: phases-deliverables, deliverables-work packages.

6. The computer program product as claimed in claim 1, wherein the fourth computer code device comprises: activity-oriented/event-driven methods for: activity definition, activity sequencing, activity resource estimation, activity duration estimating, and schedule development.

7. The computer program product as claimed in claim 1, wherein the fourth computer code device comprises cost-oriented/event-driven methods for estimation and budgeting of cost.

8. The computer program product as claimed in claim 1, wherein the fifth computer code device comprises incremental development and progressive elaboration for domain processes for the project life cycle of the currently active project profile.

9. The computer program product as claimed in claim 1, wherein the sixth computer code device comprises: variance analysis and EV algorithms for the WBS objects and entities of the currently active project.

10. The computer program product as claimed in claim 1, wherein the seventh computer code device comprises: code access security algorithms, cryptography and hash algorithms, roles authentication, and group permission algorithms.

11. The computer program product as claimed in claim 1, wherein the eighth computer code device comprises web services including data reporting.

12. The computer PM system utilizing functional layers in an N-tier, Client/Server architecture, for orchestrating plural PM entities, stages, processes and services, the functional layers comprising: means for receiving information related to a business case from plural real-time information sources; means for receiving project configuration information and setting up real-time project profile of the currently active project; means to produce a WBS having: phases/stages, deliverables and work packages; means for delivering, with incremental development: project schedule, project budget, project resources, quality, human resources, changes, procurement, and risk project requirements respectively for a currently active project profile; means to retrieve and track real time KPIs upon user request and on demand; means to provide security and access control; and means for web services.

13. The computer system as claimed in claim 12, wherein the plural PM entities, processes and services, comprise a project life cycle of: business case, initiation, planning, execution, controlling and closing stages.

14. The computer system as claimed in claim 13, wherein the initiation stage comprises: a project charter and a preliminary scope statement.

15. The computer system as claimed in claim 12, wherein the means for receiving information related to a business case, from plural real-time information sources, comprises means for requesting the event-driven services of: presentation layer, business logic, data access and security.

16. The computer system as claimed in claim 12, wherein the means for receiving project configuration information and setting up a real-time project profile of the currently active project, comprises means for requesting event-driven services of: presentation layer, data access, and security event-driven services.

17. The computer system as claimed in claim 12, wherein the means to produce a WBS, comprises means to generate object-oriented WBS entities by inheritance, and event-driven methods.

18. The computer system as claimed in claim 12, wherein the means for delivering with incremental development: project schedule, project budget, project resources, quality, procurement, human resources, changes, communication and risk project requirements, respectively, for a currently active project profile, comprises requesting event-driven client and server side services.

19. The computer system as claimed in claim 12, wherein the means to retrieve and track real time KPIs, upon user request, and on demand, comprises requesting event-driven client/server services, output of the execution processes stage and other objects of interest of the currently active project.

20. The computer system as claimed in claim 12, wherein the means to provide security and access control, comprises requesting security services for each layer.

21. The computer system as claimed in claim 12, wherein the means for web services comprises requesting web services including data reporting by means of web methods.

22. A computer-implemented method for processing PM information, with functional layers integration, and orchestrating plural PM entities, in an N-tier Client/Server architecture, the method comprising: receiving project information related to the business case, from plural real-time information sources; receiving project configuration information, and setting up a real-time project profile of the currently active project; receiving project information and generating a WBS; delivering by incremental development: the project schedule, project budget, project resources, quality, procurement, human resources, changes, communication and risk project requirements, respectively, for a currently active project profile; retrieving, generating and tracking real time KPIs, upon request and on demand; enabling security and access control at the entity, user and object levels; and providing web services including reporting data.

23. The method as claimed in claim 22, wherein receiving project information related to business case from plural real-time information sources, comprises validating data.

24. The method as claimed in claim 22, wherein receiving project configuration information and setting up a real-time project profile of the currently active project, comprises selecting preferred processes.

25. The method as claimed in claim 22, wherein receiving project information and generating a WBS, comprises processing project scope definition data.

26. The method as claimed in claim 22, wherein delivering by incremental development: the project schedule, project budget, project resources, quality, procurement, change, human resources, communication and risk project requirements, respectively, for the currently active project, comprises processing WBS information derived for the currently active profile.

27. The method as claimed in claim 22, wherein retrieving, generating and tracking real time KPIs, upon request and on demand, comprises EV and variance analysis for the currently active WBS.

28. The method as claimed in claim 22, wherein providing web services with reporting data, comprises publishing KPIs of the current invention.
